(19) United States
(12) Patent Application Publication
(10) Pub. No.: US 2013/0042887 A1
(43) Pub. Date: Feb. 21, 2013

(54) TOILET BOWL CLEANER AND METHOD

(71) Applicants: Richard W. Avery, High Wycome (GB); Kathleen A. Kochevar, Bartlett, IL (US); Russell B. Wortley, Kenosha, WI (US); Carlos Romero, Gurnee, IL (US)

(72) Inventors: Richard W. Avery, High Wycome (GB); Kathleen A. Kochevar, Bartlett, IL (US); Russell B. Wortley, Kenosha, WI (US); Carlos Romero, Gurnee, IL (US)

(21) Appl. No.: 13/580,018

(22) PCT Filed: Feb. 23, 2011
(86) PCT No.: PCT/US2011/000339

§ 371 Date: Sep. 18, 2012

Related U.S. Application Data
(60) Provisional application No. 61/307,560, filed on Feb. 24, 2010.

(51) Int. Cl. C11D 3/60; B08B 3/04

(52) U.S. Cl. 134/2; 510/191

(57) ABSTRACT

An aqueous cleaning composition and method for cleaning toilet bowl surfaces includes a composition having an acid, such as hydrochloric acid, and at least one antimicrobially active diamine surfactant such that the cleaning composition has a pH of less than 4 and a viscosity of at least 100 centipoise.

### CROSS REFERENCE TO RELATED APPLICATIONS

This Patent Cooperative Treaty international patent application claims the benefit of U.S. Provisional Patent Application No. 61/307,560 filed Feb. 24, 2010, which is also incorporated in its entirety herein by this reference.

### TECHNICAL FIELD

The present invention relates to cleaning compositions for application to hard surfaces, particularly the cleaning of toilet bowl inside surfaces. The cleaning compositions include at least one C10-C24 antimicrobially active diamine surfactant and exhibits improved fluid flow characteristics, particularly an increased viscosity of at least 100 centipoise.

### BACKGROUND

Cleaning compositions that effectively disinfect and clean hard surfaces such as those in lavatories and bathrooms, particularly toilet bowls, are well known. Typical cleaning compositions provide effective coverage of the treated surfaces to ensure that contact between the cleaning composition and contaminants present on the surface occur. Ineffective disinfection and cleaning of the surface often is the end result without such contact, particularly for inner toilet bowl surfaces. For pitched toilet bowl surfaces, viscous cleaning compositions can provide good coverage and retention, particularly vertically sloped interior surfaces of a toilet bowl. Unfortunately, the addition of various surfactants for the adjustment of cleaning composition spreading and surface wetting characteristics also reduces cleaning composition viscosity. Reduced viscosity compositions when applied to interior toilet bowl surfaces are characterized by a layer, or lamina, of applied liquid that slides down the interior of the toilet bowl and that typically separates into a number of smaller and distinct channels or rivulets. Regions of the toilet bowl interior surface that are in between the liquid channels or rivulets form untreated portions of the toilet bowl. In addition, known cleaning composition ingredients tend to separate as the composition flows on the toilet bowl surface, thus further reducing the effectiveness of the cleaning composition.

Techniques such as the reapplication of cleaning composition or the use of mechanical devices, for example a toilet bowl brush, can be used to spread the composition to the untreated areas. Both these options add additional cleaning steps in an attempt to overcoming shortcomings in the fluid properties of the cleaning composition. The additional steps do not necessarily improve cleaning composition efficacy, and thus can be wasteful in terms of requiring additional cleaning composition plus the requirement of a mechanical device.

While compositions are known to the art which provide a cleaning and optionally a disinfecting benefit to hard surfaces and particularly to lavatory appliances, there is nonetheless a real and continuing need in the art to provide still further improved compositions which provide an improved cleaning, and desirably also a simultaneous sanitizing or disinfecting benefit, to treated hard surfaces. Particularly, it would be desirable to have liquid cleaning compositions and methods useful in the treatment of hard surfaces that feature improved fluid flow properties, such as viscosity, so as to provide surface coverage when applied from a container, especially a squeeze bottle, onto a vertical or inclined hard surface, to overcome the above disadvantages.

### SUMMARY OF THE INVENTION

One aspect of the invention provides an aqueous cleaning composition for cleaning surfaces having a pH of less than 4 and including an acid, such as hydrochloric acid. The cleaning composition also includes at least one antimicrobially active diamine surfactant which is effective in increasing aqueous cleaning composition viscosity to at least 100 centipoise.

Another aspect of the invention provides an aqueous acidic cleaning composition with a pH of less than 4 and including hydrochloric acid, and at least one antimicrobially active diamine surfactant such as N-(3-aminopropyl)-N-dodecylpropane-1,3-diamine or N-alkyl aminoproply glycine. A surfactant mixture is also included as part of the cleaning composition and includes an amine oxide surfactant, an quaternary amine surfactant, an alkoxylated fatty alcohol surfactant, or an alkoxylated fatty amine surfactant, individually or in combinations. Optional ingredients of the cleaning composition include a fragrance and a dye. An unexpectantly high viscosity of the above aqueous acidic cleaning composition exceeds 100 centipoise.

Yet another aspect of the invention provides a method for cleaning a toilet bowl surface that includes providing an aqueous cleaning composition having an acid, and an antimicrobially active diamine surfactant, such that the cleaning composition has a pH of less than 4 and a viscosity of at least 100 centipoise; contacting the cleaning composition with a toilet bowl surface having contaminants; and removing the cleaning composition together with containments from the toilet bowl surface with water delivered to the toilet bowl surface by flushing the toilet.

### DETAILED DESCRIPTION

The cleaning compositions of the present invention comprise (1) an active acid component in an amount sufficient to provide a pH to the composition of about 4 or less; (2) an antimicrobially active diamine surfactant; (3) a surfactant mixture that includes surfactants and co-surfactants, individually or in combination, such as amine oxides, quaternary amines, alkoxylated fatty alcohols, and alkoxylated fatty amines; (4) water, such as deionized water; and optionally; (5) a fragrance; and (6) a water-soluble dye. The cleaning compositions have excellent cleaning performance in terms of surface disinfecting and sanitizing by antimicrobial effect, and have unexpectantly high viscosity, even without thickeners, so as to show improved flow characteristics in terms of surface spreading and contacting, surface clinging, and surface contact time.

The compositions of the invention are acidic in nature and comprise at least one inorganic and/or organic acid in a sufficient amount in order that the compositions of the invention have a pH of 4 or less. Generally, useful inorganic acids include water soluble inorganic and mineral acids. Non-limiting examples of useful acids include hydrochloric acid, phosphoric acid, sulfuric acid, and so forth individually or in combination.

As for organic acids, non-limiting examples include any known organic acid which may be found effective in the inventive compositions. Generally useful organic acids are those which include at least one carbon atom, and include at least one carboxyl group (—COOH) in its structure. More specifically, useful organic acids contain from 1 to about 6 carbon atoms, have at least one carboxyl group, and are water soluble. Non-limiting examples include acetic acid, chloroacetic acid, citric acid, formic acid, propionic acid, and so forth.

In certain embodiments of the invention, the sole acid present is hydrochloric acid to the exclusion of other acids. A suitable range of active hydrochloric acid-containing component for use in the present invention is about 2% to 20% by weight as pure hydrochloric acid (100%) in the inventive compositions.

In addition to an acid, the compositions of the invention include at least one antimicrobially active surfactant. Such surfactants provide disinfecting and sanitizing benefits to the cleaning compositions of the present invention. The antimicrobially active surfactants of the present invention include C10-20 alkyl diamines that can be nonionic, amphoteric, or zwitterionic surfactants.

Generally, antimicrobially active surfactants include anti-microbial agents or biocides that are effective in inhibiting the growth and/or destroying harmful microorganisms. Of particular interest are surfactants that have demonstrated efficacy against known and commonly occurring undesirable microorganisms such as bacteria, fungi, algae, and viruses, which are respectively designated an antibacterial, a fungicide, an algaecide, and an antiviral. Antimicrobially active surfactants that are generally effective against a plurality of microorganism types are known as an antimicrobial.

By way of non-limiting example, a list of bacteria that the antimicrobially active surfactants, which act as antibacterials, can effectively inhibit or destroy include: Bacillus cereus; Bacillus stearothermophilus; Bacillus subtilis; Bordetella bronchiseptica; Campylobacter jejuni; Clostridium perfringens; Corynebacterium xerosis; Enterococcus faecium; Enterococcus hirae; Erysipelothrix insidiosa; Escheria coli; Haemophilus pleuropneumoniae; Klebsiella pneumonia; Lactobacillus brevis; Lactobacillus casei; Lactobacillus krusei; Lactobacillus lindneri; Listeria monocytogenes; Micrococcus luterus; Pasteurella multocida; Pediococcus damnosus; Proteus mirabilis; Pseudomonas aeruginosa; Salmonella enteritis; Salmonella panama; Salmonella thyphimorium; Serratia marcescens; Staphylococcus epidermidis; Staphylococcus aureus; Streptococcus faecalis; Vibrio parahaemoliticus; and Yersinia enterocolitica.

By way of non-limiting example, a list of fungi including molds and yeasts that the antimicrobially active surfactants, which act as fungicides, can effectively inhibit or destroy include: Absidia corymbifera; Aspergillus flavus; Aspergillus niger; Candida albicans; Geotrichum candidum; Hansenula anomala; Microsporum gypseum; Monilia; Mucor; Penicillium expansum; Rhizopus; Rhodotorula; Saccharomyces bayabus; Saccharomyces carlsbergensis; Saccharomyces uvarum; Saccharomyces cerevisiae; Saccharomyces diastaticus; Trichophyton mentagrophytes; and Zygosaccharomyces bailii.

By way of non-limiting example, a list of algae that the antimicrobially active surfactants, which act as algaecides, can effectively inhibit or destroy include: Chlorella pyrenoidosa; Desmodesmus subspicatus; and Selenastrum capricornum.

By way of non-limiting example, a list of viruses that the antimicrobially active surfactants, which act as antivirals, can effectively inhibit or destroy include: Hepatitis B virus; Human immunodeficiency virus; Rotavirus strain Wa; Vaccinia virus; Bovine virus diarrhea virus; Hepatitis C virus; Herpes simplex virus; Bovine corona virus; SARS virus; Bird flu virus; and Influenza A virus.

In addition to antimicrobial activity, the antimicrobially active diamine surfactants of the present invention also unexpectantly increase the viscosity of the liquid cleaning compositions. The antimicrobially active surfactants include C10-C24 alkyl diamines that can be amphoteric or zwitterionic surfactants. The inclusion of such antimicrobially active diamine surfactants into acidic aqueous cleaning compositions not only provides excellent antimicrobial activity so as to disinfect lavatory surfaces, but also causes an increase in cleaning composition viscosity substantially greater than that of similar cleaning compositions that utilize more conventional biocidal surfactants.

Commonly known cleaning compositions typically contain conventional biocidal surfactants, such as quaternary ammonium surfactants of the general formula: RR′N+(CH3)2 Cl—, where R and R′ represents separate and distinct alkyl straight chains, such as C10-C20. Cleaning compositions that include quaternary ammonium biocide surfactants typically have a viscosity of about 12.5 centipoise. The individual ingredients of such cleaning composition formulations also tend to separate upon use. In comparison, cleaning compositions that include a comparable amount of antimicrobially active diamine surfactant have a viscosity of at least 100 centipoises.

Exemplary antimicrobially active diamine surfactants, which simultaneously provide both antimicrobial activity and substantially higher cleaning composition viscosity of at least 100 centipoises, include, but are not limited to, alkyl amino diamines and alky diamino carboxylic acids. Suitable alkyl amino diamines surfactants have the formula RN(R′NH2)2, where R is a alkyl group ranging from C8 to C24, and where each of the two amine groups (NH2) are attached to different carbon atoms, and where R′ is a lower alkyl group ranging from C1 to C5. A specific, but non-limiting, example of an antimicrobially active alkyl amino diamine surfactant that is useful in inventive cleaning compositions is N-(3-Aminopropyl)-N-dodecylpropane-1,3-diamine which is marketed by Lonza Ltd. under the trade name Lonzabac®.

In addition to alkyl amino diamines surfactants, suitable alkyl diamino carboxylic acid surfactants have a formula RNH(R′NH)nCOOH, where R is an alkyl group ranging from C10 to C24, that optionally includes oxygen containing groups including, but not limited to, carbonyls, ethers, alcohols, and so forth. R′ is a lower alkyl group ranging from C1 to C5. The number n is a whole number that can vary from 1 to 4 such that alkyl amino diamine surfactants include at least two amine groups. A non-limiting example of compounds having multiple amine groups of which one is in an amino acid group include glycines, such as 6-Dodecyl-2,6-diazahexane-1-carboxylic acid. Alternatively, methyl carboxyl groups can displace amine hydrogens to form amino acid groups some of which optionally have more than one carboxyl group.

Suitable alkyl diamino carboxylic acid surfactants for use in the inventive cleaning composition also include the partial or complete carbonoxymethylation of amines as described in U.S. Pat. No. 5,491,245 to Gruning et al. titled Method for the Synthesis of Amphorteric Surfactants, the whole of which is included by reference to be part of this specification. As described in U.S. Pat. No. 5,491,245, amines of Formula I are reacted with a halogen alkyl carboxylic acid such as choloroacetic acid or its salts to produce amphorteric surfactants including, but not limited to, amphogylinates, polybetaines, glycines, and so forth. Non-limiting examples of Formula 1 amines as disclosed in U.S. Pat. No. 5,491,245 are Formulas A, B, and C. A more specific example of useful alkyl diamino carboxylic acid surfactants disclosed in U.S. Pat. No. 5,491,245 include the reaction products of amines, N—C10-16-alkyltrimethylenedi, with chloro acetic acid which is an amphoteric surfactant marketed by Evonik Industries under the trade name REWOCID WK 30, a N-alkyl aminoproply glycine.

Besides containing an antimicrobially active diamine surfactant, typical cleaning compositions also include individual surfactants or mixtures of surfactants. As commonly practiced, surfactants are used as surface-active agents for the modification of interfacial tension between liquid and hard surfaces. Such surface-active agents typically contain both hydrophobic groups and hydrophilic groups. Without being bound by any particular theory, these surfactants operate as wetting agents that lower the surface tension of the liquid itself and lower the interfacial tension at the hard surface, allowing easier spreading. Surfactants useful in controlling characteristics such as hard surface contacting and spreading of the cleaning compositions can be anionic, cationic, non-ionic, amphoteric, and zwitterionic surfactants or appropriate combinations of surfactants. In addition, a number of individual surfactants can be mixed together to give optimal fluid characteristics and performance in terms of cleaner thickness and hard surface spreading and clinging while maintaining effective surface disinfection by not inhibiting the antimicrobially active diamine surfactants.

The cleaning compositions of the present invention include a surfactant mixture that has surfactants and co-surfactants, individually or in combination, such as amine oxides, quaternary amines, alkoxylated fatty alcohols, and alkoxylated fatty amines. In one embodiment, the surfactant mixture has one or more alkyl dimethyl amine oxide surfactant in combination with one or more cationic co-surfactant. Long-chain alkyl amine oxides with optional branching can be are used as nonionic surfactants and have the general formula RNO, where R is a linear n-alkyl ranging from C10 to C24. A suitable mixture of n-alkyl dimethyl amine oxide surfactants that can be utilized in the surfactant mixture includes at least two such amine oxide surfactants. A mixture of n-alkyl dimethyl amine oxides that includes about 60% N,N-dimethyltetradecan-1-amine oxide and about 40% N,N-dimethylhexadecan-1-amine oxide can be utilized in the surfactant mixture. In addition, the combination or mixture can include minor amounts of lower and higher chain length alkyl dimethyl amine oxides. In another embodiment, the surfactant mixture is a blend of surfactants that includes alkoxylated fatty alcohols and alkoxylated fatty amines, for example a blend of ethoxylated fatty alcohols and ethoxylated fatty amines.

In addition to an amine oxide or mixture thereof, the surfactant mixture can include one or more cationic surfactants. Suitable cationic surfactants include quaternary ammonium compounds of the general formula: RR′3N+(CH3)2 Cl—, where R represents long alkyl straight chains, such as C10-C20, and where and R′ represents short alkyl chains such as C1-C3. A more specific example of a quaternary ammonium surfactant is hexadecyl(trimethyl)ammonium chloride marketed by Akzo Nobel Surface Chemistry AB under the trade name Arquad®.

The surfactant mixture can be tailored to adjust fluid characteristics of cleaning compositions in terms of liquid spreading over solid surfaces, liquid clinging to a solid surface, liquid plasticity, and the gravitational flow of liquid across a hard surface. Without being bound by any specific theory such adjustments are made by controlling liquid and interfacial surface tensions. A non-limiting example of a surfactant mixture that is useful in cleaning composition of the present invention include about 70%-80% of a mixture of n-alkyl dimethyl amine oxides, for example, about 75%; and the balance, about 25%, made up of n-alkyl(trimethyl)ammonium chloride.

Other water soluble surfactant mixtures that can be utilized in the invention include alkoxylated fatty alcohols, alkoxylated fatty amines, and blends of these alcohols and amines. Alkoxylated fatty alcohols are commercially known as a generally nonionic or cationic class of surfactants, and have the general formula of ROH(R′O)nH, where R is a linear or branched alkyl group ranging from C8 to C24, R′ is an alkyl group ranging from C1 to C5, and n is a number that can range from 1 to 30 or higher. This type of alcohol surfactant can be the condensation product of primary or secondary higher alcohols condensed with up to 18 moles of alkyl oxide or more to produce a mixture of alkoxylated fatty alcohols. The length of the fatty acid chain and the degree of alkoxylation can be varied to achieve the correct hydrophobic and hydrophilic characteristics of the surfactant. Ethoxylated fatty alcohols, such as the product of lauryl or myristyl alcohol condensed with varying amounts of ethylene oxide, are a non-limiting example of alkoxylated fatty alcohols advantageously useful in the inventive cleaning compositions.

As for alkoxylated fatty amines, these amines are also commercially known as a generally cationic class of surfactants, and have the general formula of RNH(R′O)nH, where R is a linear or branched alkyl group ranging from C8 to C24, R′ is an alkyl group ranging from C1 to C5, and n is a number that can range from 1 to 30 or higher. This type of amine surfactant can be the condensation product of primary, secondary, or tertiary fatty amines condensed with up to 18 moles of ethylene oxide or more to produce a mixture of ethoxylated fatty amines. The length of the fatty acid chain and the degree of ethyoxylation can be varied to achieve the correct hydrophobic and hydrophilic characteristics of the surfactant. Ethoxylated fatty amines, such as the product of lauryl or myristyl amine condensed with varying amounts of ethylene oxide, are a non-limiting example of alkoxylated fatty alcohols advantageously useful in the inventive cleaning compositions.

As previously noted, the surfactant mixture can be individual surfactants or a blend of surfactants. A useful blend of alkoxylated fatty alcohols and alkoxylated fatty amines could be a blend of ethoxylated fatty alcohols and ethoxylated fatty amines. A non-limiting example of such a blend of ethoxylated fatty alcohols and ethoxylated fatty amines surfactants that can be advantageously used in the inventive cleaning compositions include a surfactant marketed under the trade name ARLYPON® VPC by Cognis Corporation.

The cleaning composition can also include optional components, such as fragrance and dyes. These additional components can be included in the cleaning compositions to enhance the smell and appearance of the compositions to make them more appealing to the end user consumer. Conventional odiferous compounds that are suitable for use in cleaning compositions include fragrances or more complex perfumes. The fragrances and perfumes can be natural or synthetically produced and can be individual or a combination of compounds and chemicals. Fragrances and perfumes suitable for use in the cleaning composition include compounds that are acid-compatible and acid-stable. A non-limiting example of such a fragrance is TNF4707, a fragrance marketed by Takasago International Corp. A suitable acid-stable fragrance may be included, up to a level of about 0.05% to 1.0%.

Besides fragrance, one or more colorant can be added to the cleaning compositions that are useful to modify composition appearance to produce a user-pleasing color and tint. Colorants are also useful in improving the visibility of the cleaning composition that has been applied to the surface being treated, particularly toilet bowl inside surfaces. Known pigments and dyes useful as cleaning composition colorants include, but are not limited to, the United States Food and Drug Administration list of Food, Drug, and Cosmetic (FD&C) approved dyes. Generally, very small amounts of acid-stable colorants are useful to impart color to cleaning compositions. An example of a cleaning composition colorant includes Acid Blue No. 9 added at about 0.005%.

Application and Use

The cleaning compositions discussed above are viscous liquids that are used as toilet bowl cleaners. As a toilet bowl cleaner, the method of using the cleaning composition includes the steps of: i) providing a cleaning composition comprising an acid and an antimicrobially active diamine surfactant, the cleaning composition having a pH of less than 4 and a viscosity of at least 100 centipoises; ii) contacting the cleaning composition with a soiled portion of the toilet bowl surface having containments that adhere to the toilet bowl surface; and iii) removing the cleaning composition together with the containments from the soiled portion of the toilet bowl surface with a stream of water delivered to the surface by flushing the toilet.

In addition, the toilet bowl cleaner disinfects and cleans toilet bowl surfaces, and the method of using the cleaning composition on a surface also includes disinfecting the surface such as the inside surface of a toilet bowl through the contact of microorganisms on the toilet bowl surface with the cleaning composition.

Formulations

Examples of cleaning compositions according to the invention are set forth below to show that the inventive cleaning compositions having antimicrobially active diamine surfactants have a liquid viscosity greater than 100 centipoise. Those skilled in the art will appreciate that the cleaning composition of the present invention can be any suitable aqueous acidic compositions having antimicrobially active diamine surfactants that are effective against a number of commonly known undesirable microorganisms.

Besides water, acid is a major ingredient, based on weight, of the cleaning composition. Hydrochloric acid is a typical acid used to acidify cleaning compositions.

In addition to water and acid, the cleaning compositions include a number of different types of surfactants. One of the surfactants is an antimicrobially active diamine. This type of surfactant not only acts to clean and disinfect the surface but, when included in an inventive cleaning composition, such diamine surfactants result in substantially increasing cleaning composition viscosity. Antimicrobially active diamine surfactants include, but are not limited to, alkyl amino diamines surfactants, such as N-(3-Aminopropyl)-N-dodecylpropane-1,3-diamine (Lonzabac®-12.100), and alkyl diamino carboxylic acid surfactants, such as the reaction products of amines, N—C10-16 -alkyltrimethylenedi, with chloro acetic acid (REWOCID WK 30).

Further to an antimicrobially active diamine surfactant, a surfactant mixture, which can include a number of additional surfactants, is part of the inventive cleaning compositions. Such surfactants and mixtures are used to modify the fluid characteristics like the flow and surface interaction properties of the cleaning composition. In this regard, a suitable surfactant mixture includes about 75 wt % alkyl dimethyl amine oxides, such as a blend of about 60% N,N-dimethyltetradecan-1-amine oxide and 40% N,N-dimethylhexadecan-1-amine oxide (Ammonyx® X2182); and about 25 wt % of a quaternary ammonium surfactant, such as hexadecyl(trimethyl)ammonium chloride (Arquad® 16-29).

Those skilled in the art will appreciate that the cleaning compositions can further include optional ingredients such as a fragrance and/or a colorant. A suitable acid-soluble and acid-stable fragrance for use in aqueous acidic cleaning compositions includes, but is not limited to, Takasago TNF4707 marketed by Takasago International Corporation. A suitable colorant or dye for use in such cleaning compositions includes, but is not limited to, Acid Blue No. 9.

An example of a cleaning composition formulation according to the invention is as follows:

TABLE 1
Cleaning Composition Formulation

| Ingredients | Wt. % |
|---|---|
| Hydrochloric Acid-100% (Acidifier) | 2-20 |
| C8-24 alkyl diamine surfactant (Antimicrobially | 0.1-0.7 |
| active surfactant) | |
| Surfactant Mixture (1) | |
| C10-C12 Quaternary Amine (Surfactant) | 0.5-3 |
| Dimethyl C14-C18 Alkyl Amine Oxides | 2-6 |
| (Surfactant) | |
| Blend of Ethoxylated Fatty Alcohols and | 0.5-4 |
| Ethoxylated Fatty Amines (Surfactant) | |
| Fragrance | 0.05-1.0 |
| Dye | 0-0.15 |
| Deionized Water | Balance |
| | to 100% |

(1) Surfactant mixture can include each identified surfactant individually or in combination with other identified surfactants.

Experimental Results

### EXAMPLE 1

A sample of a specific cleaning composition formulation was prepared using a series of steps that include mixing the various ingredients together. Without being bound by any specific recipe for cleaning composition preparation, a description follows of how the example cleaning composition was prepared.

An initial acidic aqueous solution was prepared by mixing hydrochloric acid (32%) into deionized water. A surfactant mixture was added to the acidic aqueous solution. Although a specific order of surfactant addition was used in the experiment, the addition of the surfactant mixture can proceed in a number of ways. One way is to add and mix the individual surfactants together and then add the surfactant mixture to the acidic aqueous solution. Alternatively, each individual surfactant can be added and mixed directly into the acidic aqueous solution. The order of individual surfactant addition to a surfactant mixture or directly into the acidic aqueous solution can vary; however, it is believed that the cleaning composition properties are independent of the order of surfactant addition into the acidic aqueous solution, whether individually or as a mixture.

For this example, the individual surfactant components that make up the surfactant mixture were added directly to the acidic aqueous solution and the solution was mixed before adding the next surfactant component. The resulting acidic aqueous solution was also mixed after the last surfactant was added. More specifically for this example, quaternary amine (Arquad® 16-29) was added to the acidic aqueous solution and the resultant solution was mixed, and then an amine oxide blend (Ammonyx® X2182) was added and the resultant solution was mixed.

The addition of optional ingredients, fragrance and color, to the acidic aqueous solution followed surfactant mixture addition. The fragrance, Takasago TNF4707, was added and the solution mixed. Next a dye, Acid Blue No. 9, was added and the resultant solution mixed.

Before adding the antimicrobially active diamine surfactant to the acidic aqueous solution, visual and physical characteristics of the solution were observed and measured. The visual characteristics observed after mixing the ingredients present in the solution was the separation of ingredients. The measured physical characteristic of the solution was a relatively low viscosity of 12.5 centipoise.

The last ingredient to be added to the relatively low viscosity acidic solution to form the cleaning composition was the antimicrobially active diamine surfactant. Lonzabac® 12.100 (90% active) was the antimicrobially active diamine surfactant used in this first example. After addition of the diamine surfactant, the solution was mixed. In addition, extra deionized water was added and mixed in as necessary to finalize the cleaning composition for comparison with other example formulations.

Adding the antimicrobially active diamine surfactant to the acidic aqueous solution and mixing the solution produced a dramatic and unexpected result in terms of visual and physical characteristics of the resultant cleaning composition. For this example, the resultant cleaning composition exhibited good ingredient stability by virtue of the fact that no separation of the ingredients was observed. In addition, the viscosity of the cleaning composition was an unexpectantly high value of 275 centipoise, which was a significant increase above the 12.5 centipoise viscosity of the solution before the antimicrobially active diamine surfactant was added. Thus, about a 260 centipoise increase in viscosity was attributable to the addition of the Lonzabac® 12.100 surfactant.

The formulation of the cleaning composition in Example 1 is as follows:

TABLE 2
Cleaning Composition--Example 1

| Ingredients | Wt. % |
|---|---|
| Hydrochloric Acid-32% (Acidifier) | 29.400 |
| C8-24 alkyl diamine surfactant (Antimicrobially | 0.167 |
| active surfactant) (1) | |
| Surfactant Mixture | |
| C10-C12 Quaternary Amine (Surfactant) | 1.350 |
| Dimethyl C14-C18 Alkyl Amine Oxides | 4.500 |
| (Surfactant) | |
| Fragrance | 0.100 |
| Dye | 0.005 |
| Deionized Water | Balance |
| | to 100% |

(1) Antimicrobially active diamine surfactant is Lonzabac ®-12.100 (90% active).

### EXAMPLE 2

A second formulation of a cleaning composition was prepared. The approach used to prepare the second example formulation was the same as that used to prepare the first example compositions discussed above. Again, an acidic aqueous solution was prepared before adding the antimicrobially active diamine surfactant. The solution of this second formulation also included deionized water, hydrochloric acid (32%), a surfactant mixture (Argued® 16-29 and Ammonyx® X2182), a fragrance (Takasago TNF4707), and a dye (Acid Blue No. 9). Ingredients were added and mixed in the order given.

As in the previous example, visual and physical characteristics of the solution were observed and measured before adding the antimicrobially active diamine surfactant to the acidic aqueous solution. Again, after mixing, visual observation revealed the solution instable, as solution ingredients were seen to separate. As for physical characteristic and similar to the previous example, the measured viscosity of the solution was a relatively low 12.5 centipoise.

Again, as in the first example, the antimicrobially active diamine surfactant was added to the relatively low viscosity solution and mixed. For this experiment, the antimicrobially active diamine surfactant used was Rewocid WK (30% active).

Adding the antimicrobially active diamine surfactant to the acidic aqueous solution and mixing the solution produced a dramatic and totally unexpected result in terms of visual and physical characteristics. For this example, the resultant cleaning composition exhibited good ingredient stability by virtue of the fact that no separation of the ingredients was observed. In addition, a superior viscosity, which was even greater than the viscosity measured in the first example, was noted. The viscosity of the cleaning composition unexpectantly increased to 438 centipoise, which was a significant increase above the 12.5 centipoise viscosity of the solution before the antimicrobially active diamine surfactant was added. Thus, about a 425 centipoise increase in cleaning composition viscosity was attributable to the addition of the Rewocid WK (30% active) surfactant.

The formulation of cleaning composition in Example 2 is as follows:

TABLE 3
Cleaning Composition--Example 2

| Ingredients | Wt. % |
|---|---|
| Hydrochloric Acid-32% (Acidifier) | 29.400 |
| C8-24 alkyl diamine surfactant (Antimicrobially | 0.500 |
| active surfactant) (1) | |
| Surfactant Mixture | |
| C10-C12 Quaternary Amine (Surfactant) | 1.350 |
| Dimethyl C14-C18 Alkyl Amine Oxides | 4.500 |
| (Surfactant) | |
| Fragrance | 0.100 |
| Dye | 0.005 |
| Deionized Water | Balance |
| | to 100% |

(1) Antimicrobially active diamine surfactant is Rewocid WK (30% active).

### EXAMPLE 3

Another formulation of a cleaning composition was prepared. The approach used to prepare this third formulation was similar to the approach used in the previous examples discussed above. For the third formulation, an acidic aqueous solution was prepared before adding a biocidal surfactant. In this example, the biocidal surfactant was a quaternary amine that was distinctly different from the antimicrobially active diamine surfactants used in Examples 1 and 2.

As in the other examples, the acidic aqueous solution included deionized water, hydrochloric acid (32%), a surfactant mixture (Arquad® 16-29 and Ammonyx® X2182), a fragrance (Takasago TNF4707), and a dye (Acid Blue No. 9). The ingredients of this example were added and mixed in the order given, which was the same procedure used in the previous examples.

Again, visual and physical characteristics of the solution were observed and measured before adding the biocidal surfactant to the acidic aqueous solution. Unlike the previous two examples, there was essentially no change in the visual and physical characteristics observed before and after adding the biocidal surfactant. For this example, the ingredients of the final unstable solution mixture were seen to physically separate from each other, and the measured viscosity of the solution was an unchanged and a relatively low 12.5 centipoise.

The biocidal quaternary amine surfactant used in Example 3 was chemically distinguishable from the antimicrobially active diamine surfactants used in Examples 1 and 2. Even so, a comparable amount of the biocidal quaternary amine surfactant was added to the relatively low viscosity acidic aqueous solution and mixed. For this example, 0.300 weight percent of the biocidal surfactant (Arquad® 2.10 (50% active)) was added to the solution, a level comparable to the levels used for the antimicrobially active diamine surfactants in the previous examples; however, for this third formulation no change in viscosity was noted. In addition, the ingredients of the resultant cleaning composition were observed to separate both before and after the addition of the biocidal quaternary amine surfactant. Thus, the addition of the Arquad® 2.10 surfactant had no or at best a minimal impact on both cleaning composition viscosity and ingredients separation.

### EXAMPLE 4

A fourth formulation of a cleaning composition included a different surfactant mixture than the previous examples. The approach used to prepare the fourth formulation was similar to the approach used in the previous examples discussed above except for the different surfactant mixture. For the fourth formulation, an acidic aqueous solution was prepared before adding the antimicrobially active diamine surfactant, Rewocid WK (30% active), the same surfactant used in Example 2.

In this example, the acidic aqueous solution included deionized water, hydrochloric acid (32%), a surfactant mixture (ARLYPON® VPC), a fragrance (Norseman), and a dye (Acid Blue No. 9). The ingredients of this example were added and mixed consistent with the approach used in the previous examples.

Again, as in Example 2, the antimicrobially active diamine surfactant used in this cleaning composition formulation was Rewocid WK (30% active).

Adding the antimicrobially active diamine surfactant to the acidic aqueous solution to produce the cleaning composition produced improved visual and physical characteristics. For this example, the resultant cleaning composition exhibited good ingredient stability by virtue of the fact that no separation of the ingredients was observed. In addition, a relatively high viscosity of 413 centipoise was measured. This viscosity exceeded that of the acidic aqueous solution that included only the ARLYPON® VPC surfactant. Thus, this example again demonstrates an unexpected increase in viscosity that is attributable to the antimicrobially active diamine surfactant, which in this example was Rewocid WK (30% active).

The formulation of cleaning composition in Example 4 is as follows:

TABLE 4
Cleaning Composition--Example 4

| Ingredients | Wt. % |
|---|---|
| Hydrochloric Acid-32% (Acidifier) | 29.400 |
| C8-24 alkyl diamine surfactant (Antimicrobially | 0.500 |
| active surfactant) (1) | |
| Surfactant Mixture | |
| Blend of Ethoxylated Fatty Alcohols and | 2.000 |
| Ethoxylated Fatty Amines (Surfactant) | |
| Fragrance | 0.100 |
| Dye | 0.005 |
| Deionized Water | Balance |
| | to 100% |

(1) Antimicrobially active diamine surfactant is Rewocid WK (30% active).

While the embodiments of the invention disclosed herein are presently considered to be preferred, various changes and modifications can be made without departing from the scope of the invention. The scope of the invention is indicated in the appended claims, and all changes that come within the meaning and range of equivalents are intended to be embraced therein.

1. An aqueous cleaning composition for cleaning surfaces comprising:
an acid;
at least one antimicrobially active diamine surfactant; and
wherein the aqueous cleaning composition has a pH of less than 4 and a viscosity of at least 100 centipoise.

2. The aqueous cleaning composition of claim 1, wherein the acid is selected from the group consisting of: hydrochloric acid, phosphoric acid, sulfuric acid, acetic acid, chloroacetic acid, citric acid, formic acid, and propionic acid; and combinations thereof.

3. The aqueous cleaning composition of claim 1, wherein the at least one antimicrobially active diamine surfactant is an alkyl amino diamine having a general formula RN(R′NH2)2, wherein R is an alkyl group ranging from C8 to C24, and wherein R′ is an alkyl group ranging from C1 to C5.

4. The aqueous cleaning composition of claim 3, wherein the alkyl amino diamine is N-(3-aminopropyl)-N-dodecylpropane-1,3-diamine.

5. The aqueous cleaning composition of claim 1, wherein the at least one antimicrobially active diamine surfactant is an alkyl diamino carboxylic acid having a general formula RNH(R′NH)nCOOH, where R is an alkyl group ranging from C10 to C24, that can optionally include oxygen containing groups, R′ is an C1 to C5 alkyl group, and n is a number from 1 to 4.

6. The aqueous cleaning composition of claim 5, wherein the alkyl diamino carboxylic acid is N-alkyl aminoproply glycine.

7. The aqueous cleaning composition of claim 1, wherein, the antimicrobially active diamine surfactant is selected from the group consisting of: an antibacterial, a fungicide, an algaecide, an antiviral, and an antimicrobial; and combinations thereof.

8. The aqueous cleaning composition of claim 7, wherein, the antimicrobially active diamine surfactant comprises an antibacterial that can effectively inhibit or destroy bacteria selected from the group consisting of: Bacillus cereus; Bacillus stearothermophilus; Bacillus subtilis; Bordetella bronchiseptica; Campylobacter jejuni; Clostridium perfringens; Corynebacterium xerosis; Enterococcus faecium; Enterococcus hirae; Erysipelothrix insidiosa; Escheria coli; Haemophilus pleuropneumoniae; Klebsiella pneumonia; Lactobacillus brevis; Lactobacillus casei; Lactobacillus krusei; Lactobacillus lindneri; Listeria monocytogenes; Micrococcus luterus; Pasteurella multocida; Pediococcus damnosus; Proteus mirabilis; Pseudomonas aeruginosa; Salmonella enteritis; Salmonella panama; Salmonella thyphimorium; Serratia marcescens; Staphylococcus epidermidis; Staphylococcus aureus; Streptococcus faecalis; Vibrio parahaemoliticus; Yersinia enterocolitica; and combinations thereof.

9. The aqueous cleaning composition of claim 7, wherein, the antimicrobially active diamine surfactant comprises a fungicide that can effectively inhibit or destroy fungi selected from the group consisting of: Absidia corymbifera; Aspergillus flavus; Aspergillus niger; Candida albicans; Geotrichum candidum; Hansenula anomala; Microsporum gypseum; Monilia; Mucor; Penicillium expansum; Rhizopus; Rhodotorula; Saccharomyces bayabus; Saccharomyces carlsbergensis; Saccharomyces uvarum; Saccharomyces cerevisiae; Saccharomyces diastaticus; Trichophyton mentagrophytes; Zygosaccharomyces bailii; and combinations thereof.

10. The aqueous cleaning composition of claim 7, wherein, the antimicrobially active diamine surfactant comprises an algaecide that can effectively inhibit or destroy algae selected from the group consisting of: Chlorella pyrenoidosa; Desmodesmus subspicatus; Selenastrum capricornum; and combinations thereof.

11. The aqueous cleaning composition of claim 7, wherein, the antimicrobially active diamine surfactant comprises an an antiviral that can effectively inhibit or destroy viruses selected from the group consisting of: Hepatitis B virus; Human immunodeficiency virus; Rotavirus strain Wa; Vaccinia virus; Bovine virus diarrhea virus; Hepatitis C virus; Herpes simplex virus; Bovine corona virus; SARS virus; Bird flu virus; and Influenza A virus; and combinations thereof.

12. The aqueous cleaning composition of claim 1, further comprising a surfactant mixture, wherein the surfactant mixture includes at least one surfactant selected from the group consisting of: an amine oxide, a quaternary amine, an alkoxylated fatty alcohol, and an alkoxylated fatty amine.

13. The aqueous cleaning composition of claim 1, further comprising at least one optional ingredient selected from the group consisting of: a fragrance, and a dye; and combinations thereof.

14. The aqueous cleaning composition of claim 1, wherein the aqueous cleaning composition has a viscosity of at least 250 centipoise.

15. An aqueous cleaning composition for cleaning surfaces comprising:
an acid;
an antimicrobially active diamine surfactant selected from the group consisting of:
N-(3-aminopropyl)-N-dodecylpropane-1,3-diamine, and N-alkyl aminoproply glycine; and combinations thereof;
a surfactant mixture, wherein the surfactant mixture includes at least one surfactant selected from the group consisting of: an amine oxide, a quaternary amine, an alkoxylated fatty alcohol, and an alkoxylated fatty amine;
an optional fragrance;
an optional dye, and
wherein the aqueous cleaning composition has a pH of less than 4 and a viscosity of at least 100 centipoise.

16. The aqueous cleaning composition of claim 15, wherein the antimicrobially active diamine surfactant is N-alkyl aminoproply glycine.

17. The aqueous cleaning composition of claim 15, wherein the aqueous cleaning composition has a viscosity of at least 250 centipoise.

18. A method for cleaning a toilet bowl surface comprising:
providing a cleaning composition including an acid, an antimicrobially active diamine surfactant, and wherein the cleaning composition has a pH of less than 4 and a viscosity of at least 100 centipoises;
contacting the cleaning composition with a toilet bowl surface having contaminants; and
removing the cleaning composition together with containments from the toilet bowl surface a stream of water delivered to the toilet bowl surface.

19. The method of claim 18, further comprising the step of disinfecting the toilet bowl surface by contacting microorganisms with the cleaning composition.

20. The aqueous cleaning composition of claim 18, wherein the aqueous cleaning composition has a viscosity of at least 250 centipoise.
